(19) United States
(12) Patent Application Publication
(10) Pub. No.: US 2013/0110624 A1
(43) Pub. Date: May 2, 2013

(54) METHODS AND SYSTEMS FOR ASSESSING EXCESSIVE ACCESSORY LISTINGS IN SEARCH RESULTS

(71) Applicant: Ivan Mitrovic, Charlestown, MA (US)

(72) Inventor: Ivan Mitrovic, Charlestown, MA (US)

(73) Assignee: eBay Inc., San Jose, CA (US)

(21) Appl. No.: 13/282,199

(22) Filed: Oct. 26, 2011

(51) Int. Cl. G06Q 30/02

(52) U.S. Cl. 705/14.53

(57) ABSTRACT

Systems and methods to deliver a location-aware offer based on past demonstrated intent to purchase are discussed. For example, a method to deliver a location-aware offer can include operations for receiving a current location, determining when the user is within a pre-defined proximity to a merchant location, accessing user profile data, generating an offer, and delivering the offer to a client device. The current location can represent the physical location of a client device. The user profile data including an intended purchase list. Generating the offer includes matching inventory available at the merchant location to an item on the intended purchase list.

### TECHNICAL FIELD

This application relates generally to data processing within a network-based system operating over a distributed network, and more specifically to systems and methods to deliver location-aware offers based on missed purchase opportunities.

### BACKGROUND

The ever increasing use of smart phones, such as the iPhone® (from Apple, Inc. of Cupertino Calif.), with data connections and location determination capabilities is slowly changing the way people shop for products and services. Smart phones can provide users with nearly instant information for price comparison purposes. For example, applications such as RedLaser™ (from eBay, Inc. of San Jose, Calif.) allow a smart phone user to scan a bar code and instantly check prices across online and local retail outlets. Smart phones also commonly include mechanisms, such as global positioning satellite (GPS) receivers, that allow the devices to constantly update location information.

### BRIEF DESCRIPTION OF THE DRAWINGS

Some embodiments are illustrated by way of example and not limitation in the figures of the accompanying drawings in which:

FIG. 1 is a block diagram depicting a system for delivering location-aware offers, according to an example embodiment.

FIG. 2 is a block diagram illustrating an environment for operating a mobile device, according to an example embodiment.

FIG. 3 is a block diagram illustrating a mobile device, according to an example embodiment.

FIG. 4 is a block diagram illustrating a network-based system for delivering location-aware offers based on missed purchase opportunities, according to an example embodiment.

FIG. 5 is a block diagram illustrating offer modules, according to an example embodiment.

FIG. 6 is a flowchart illustrating a method for delivering offers based on missed purchase opportunities, according to an example embodiment.

FIG. 7 is a flowchart illustrating a method for receiving location-aware offers based on missed purchase opportunities, according to an example embodiment.

FIG. 8 is a swim-lane chart illustrating a method for providing location-aware offers based on missed purchase opportunities, according to an example embodiment.

FIG. 9 is a diagrammatic representation of a machine in the example form of a computer system within which a set of instructions for causing the machine to perform any one or more of the methodologies discussed herein may be executed.

### DEFINITIONS

Location—For the purposes of this specification and the associated claims, the term “location” is used to refer to a geographic location, such as a longitude/latitude combination or a street address. The term location is also used within this specification in reference to a physical location associated with a retail outlet (e.g., store).

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

### Detailed Description

Example systems and methods for delivering location-aware offers based on missed purchase opportunities are described. In some example embodiments, the systems and methods for delivering location-aware offers may provide merchants the ability to target customers based on past behavior and current context (e.g., location) of a user interacting with retail locations utilizing a network-based publication system. In the following description, for purposes of explanation, numerous specific details are set forth in order to provide a thorough understanding of example embodiments. It will be evident, however, to one skilled in the art that the present invention may be practiced without these specific details. It will also be evident that a real-time location-aware offer publication system is not limited to the examples provided and may include other scenarios not specifically discussed.

In accordance with an example embodiment, a network-based system can provide a platform to deliver location-aware offers based on missed purchase opportunities. In certain examples, the missed purchase opportunities can leverage past user interactions with the network-based system. In some examples, the user interacts with a network-based system via a mobile device, such as a smartphone, a tablet computing device, or an Internet enabled personal digital assistant (PDA), among others. In an example, the network-based system can include a publication module capable of delivering location-aware offers to a user based on stored user profile data and local merchant inventory.

In an example scenario, the network-based publication system can utilize information regarding an auction lost by a user to deliver an offer for a similar item from a local merchant when the user travels within a pre-defined proximity of the merchant (e.g., a physical retail location operated by the merchant). For example, user X bid $45 for a cordless drill on a network-based marketplace that the network-based publication system can access. In this example, user X does not have the winning bid, as the drill sells for $48. At a later time, user X visits a local hardware store that sells the same drill. The local hardware store normally sells the drill for $54. However, in this example, the network-based publication system detects that user X is in the hardware store, that the hardware store has the drill in inventory, and that the hardware store has indicated a willingness to sell the drill at user X's previously bid price of $45. Accordingly, the network-based publication system can deliver an offer to user X's mobile device, providing user X an opportunity to purchase the drill for $45 at the local hardware store.

The offer generation system can utilize any implicit or explicit actions associated with a user that can be recorded and stored for future analysis. Companies that provide services, sell merchandise, or provide information over a network, such as the Internet, commonly track user information. For example, Google (of Mountain View, Calif.) collects a wide variety of data about users of its various services. Google even provides individual users with the ability to download all of this data via the Google Dashboard. In an example, a network-based publication system can maintain an intended purchase list for each user that includes a list of products and services that the user has demonstrated an interest in purchasing (implicitly or explicitly). Table 1 contains an example list of actions a network-based publication system can analyze to populate an intended purchase list:

TABLE 1
Demonstrated Purchase Interest

Coupons added to a virtual wallet
Losing an auction after placing a bid
Not bidding on a watched auction
Abandoning a virtual shopping cart with items in the shopping cart
Researching a particular product or service
Reading an article related to a particular product or service
Searching on product or service specific keywords
Wish lists include particular products or services
Viewing a coupon, deal, or email related to a particular product or service
Clicking on an advertisement for a particular product or service
Blog posts discussing a particular product or service
Tweeting about a particular product or service
Social network entry regarding a particular product or service

### Example System

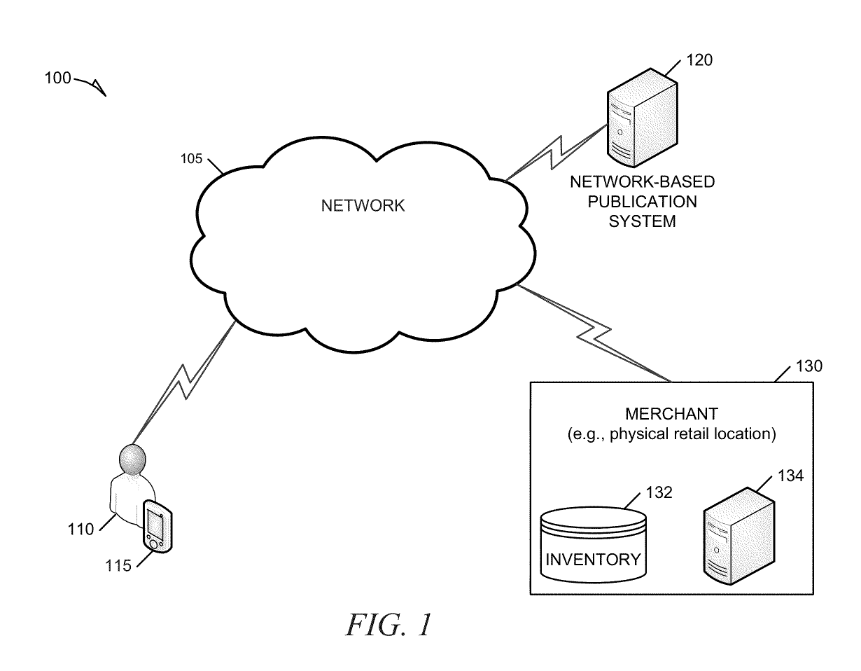

FIG. 1 is a block diagram depicting a system 100 for delivering location-aware offers, according to an example embodiment. The system 100 can include a user 110, a network-based publication system 120, and a merchant 130. In an example, the user 110 can connect to the network-based publication system 120 via a client device, such as a mobile device 115 (e.g., smart phone, PDA, laptop, or similar mobile electronic device capable of some form of data connectivity). In an example, the merchant 130 can operate computer systems, such as an inventory system 132 or a merchandizing system 134. The network-based publication system 120 can interact with any of the systems used by merchant 130 for operation of the merchant's retail or service business. In an example, the network-based publication system 120 can work with both merchandizing system 134 and inventory system 132 to obtain access to inventory available at individual retail locations run by the merchant and match merchandise on which the merchant wants to offer deals with missed purchase opportunities extracted from user profile data associated with user 110. For example, the merchant 130 can create rule-based instructions for use by the network-based publication system 120 in generating offers based on available inventory. In certain examples, the merchant 130 can maintain the rule-based instructions within a locally operated merchandizing system 134 that can communicate with the network-based publication system 120 over the network 105. In another example, the merchant 130 can access the network-based publication system 130 via a web interface to create rule-based instructions for use in generating offers.

In general, offers can be generated by the network-based publication system 120 based on any explicit or implicit indication of intent by a user. Publication or electronic commerce platforms can capture information about a user ranging from browsing patterns to wish lists to virtual shopping carts. Many different purchase intents can be derived from this wealth of information. For example, if a user spends a great deal of time browsing informational pages related to a particular product or service, an online system, such as the network-based publication system 120, can infer that the user has an interest in purchasing that particular product or service. An online system may use more explicit indications of purchase intent, such as the user adding an item to a wish list or a virtual shopping cart. In the case of the virtual shopping cart, an online system may be able to track when a user abandons a virtual shopping cart without making a purchase. The products or services within the abandoned virtual shopping cart could then be added to a list of intended purchases (as the user explicitly demonstrated some level of interest in the products or services by adding them to a shopping cart).

The network-based publication system 120 can maintain an intended purchase list for each user (such as user 110). The intended purchase lists can be used in conjunction with local inventory for participating merchants and offer generation rules to generate real-time location-aware offers based on a user's actual interests.

### Example Operating Environment

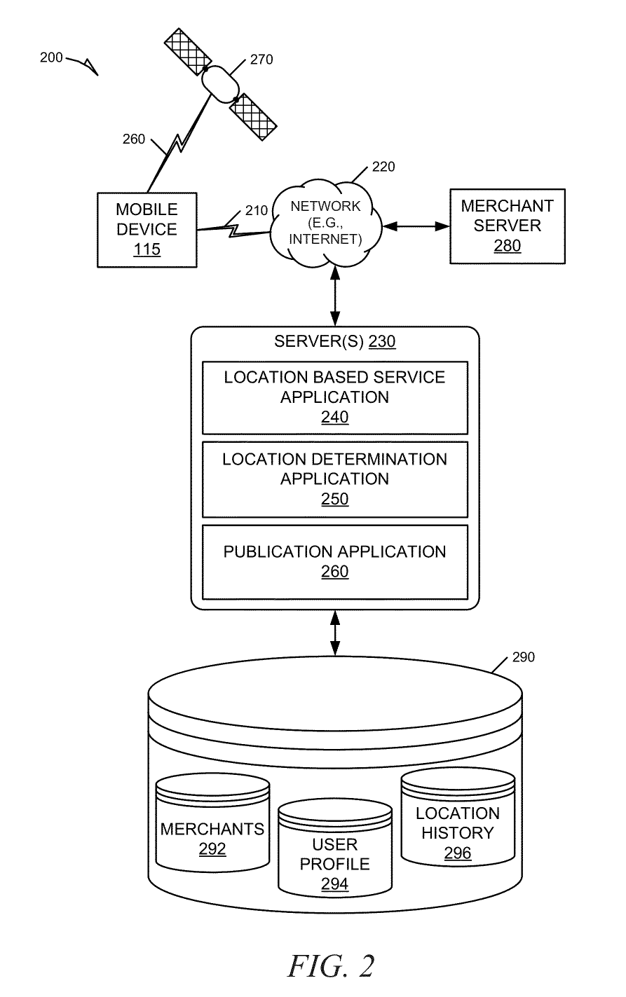

FIG. 2 is a block diagram illustrating an environment 200 for operating a mobile device 115, according to an example embodiment. The environment 200 is an example environment within which methods of delivering location-aware offers based on missed purchase opportunities can be operated. The environment 200 can include a mobile device 115, a communication connection 210, a network 220, servers 230, a communication satellite 270, a merchant server 280, and a database 290. The servers 230 can optionally include location based service application 240, location determination application 250, and publication application 260. The database 290 can optionally include merchant databases 292, user profile database 294, and/or location history database 296. The mobile device 115 represents one example device that can be utilized by a user to receive offers and share information about missed purchase opportunities. The mobile device 115 may be any of a variety of types of devices (for example, a cellular telephone, a personal digital assistant (PDA), a Personal Navigation Device (PND), a handheld computer, a tablet computer, a notebook computer, or other type of movable device). The mobile device 115 may interface via a connection 210 with a communication network 220. Depending on the form of the mobile device 115, any of a variety of types of connections 210 and communication networks 220 may be used.

For example, the connection 210 may be Code Division Multiple Access (CDMA) connection, a Global System for Mobile communications (GSM) connection, or other type of cellular connection. Such connection 210 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the communication network 220 may include a cellular network that has a plurality of cell sites of overlapping geographic coverage, interconnected by cellular telephone exchanges. These cellular telephone exchanges may be coupled to a network backbone (for example, the public switched telephone network (PSTN), a packet-switched data network, or to other types of networks).

In another example, the connection 210 may be Wireless Fidelity (Wi-Fi, IEEE 802.11x type) connection, a Worldwide Interoperability for Microwave Access (WiMAX) connection, or another type of wireless data connection. In such an embodiment, the communication network 220 may include one or more wireless access points coupled to a local area network (LAN), a wide area network (WAN), the Internet, or other packet-switched data network.

In yet another example, the connection 210 may be a wired connection, for example an Ethernet link, and the communication network may be a LAN, a WAN, the Internet, or other packet-switched data network. Accordingly, a variety of different configurations are expressly contemplated.

A plurality of servers 230 may be coupled via interfaces to the communication network 220, for example, via wired or wireless interfaces. These servers 230 may be configured to provide various types of services to the mobile device 115. For example, one or more servers 230 may execute location based service (LBS) applications 240, which interoperate with software executing on the mobile device 115, to provide LBSs to a user. LBSs can use knowledge of the device's location, and/or the location of other devices, to provide location-specific information, recommendations, notifications, interactive capabilities, and/or other functionality to a user. For example, an LBS application 240 can provide location data to a network-based publication system 120, which can then be used to assist in generating offers relevant to the user's current location, Knowledge of the device's location, and/or the location of other devices, may be obtained through interoperation of the mobile device 115 with a location determination application 250 executing on one or more of the servers 230. Location information may also be provided by the mobile device 115, without use of a location determination application, such as application 250. In certain examples, the mobile device 115 may have some limited location determination capabilities that are augmented by the location determination application 250. In some examples, the servers 230 can also include publication application 260 for providing location-aware offers that may be triggered by past missed purchase opportunities. In certain examples, location data can be provided to the publication application 260 by the location determination application 250. In some examples, the location data provided by the location determination application 250 can include merchant information (e.g., identification of a retail location). In certain examples, the location determination application 250 can receive signals via the network 220 to further identify a location. For example, a merchant may broadcast a specific IEEE 802.11 service set identifier (SSID) that can be interpreted by the location determination application 250 to identify a particular retail location. In another example, the merchant may broadcast an identification signal via radio-frequency identification (RFID), near-field communication (NFC), or a similar protocol that can be used by the location determination application 250.

### Example Mobile Device

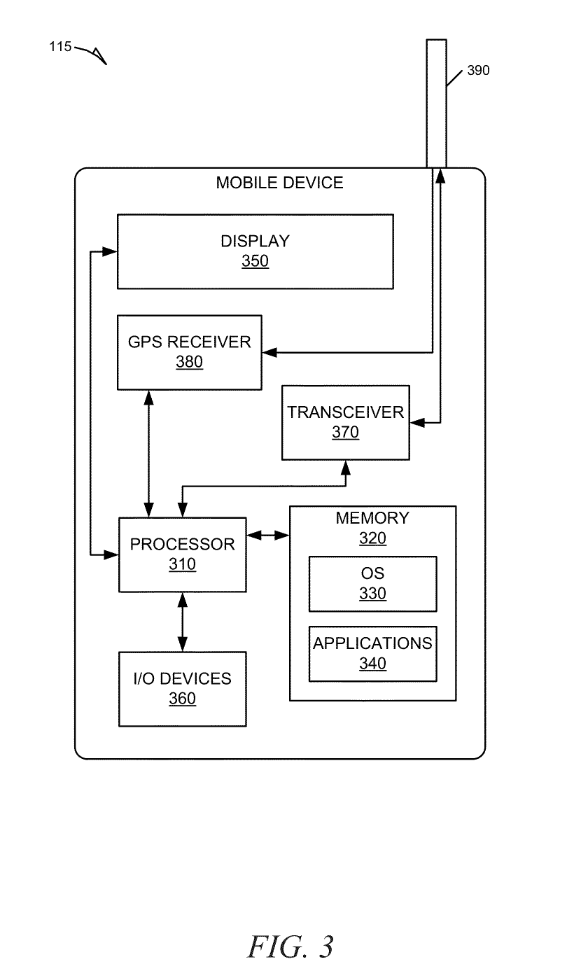

FIG. 3 is a block diagram illustrating the mobile device 115, according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor. The memory 320 may be adapted to store an operating system (OS) 330, as well as application programs 340, such as a mobile location enabled application that may provide LBSs to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. In this manner, the connection 210 with the communication network 220 may be established. Further, in some configurations, a GPS receiver 380 may also make use of the antenna 390 to receive GPS signals.

Additional detail regarding providing and receiving location-based services can be found in U.S. Pat. No. 7,848,765, titled “Location-Based Services,” granted to Phillips et al, and assigned to Where, Inc. of Boston, Mass., which is hereby incorporated by reference.

A geo-location concept discussed within U.S. Pat. No. 7,848,765 is a geofence. A geofence can be defined as a perimeter or boundary around a physical location. A geofence can be as simple as a radius around a physical location defining a circular region around the location. However, a geofence can be any geometric shape or an arbitrary boundary drawn on a map. A geofence can be used to determine a geographical area of interest for calculation of demographics, advertising, or similar purposes. Geofences can be used in conjunction with the offer generation and delivery concepts discussed herein. For example, a geofence can be used to assist in determining whether a user (or mobile device associated with the user) is within a geographic area of interest to a particular merchant. If the user is within a geofence established by the merchant, the systems discussed herein can use that information to generate an offer from the merchant and deliver the offer to the user (e.g., via a mobile device associated with the user).

### Example Platform Architecture

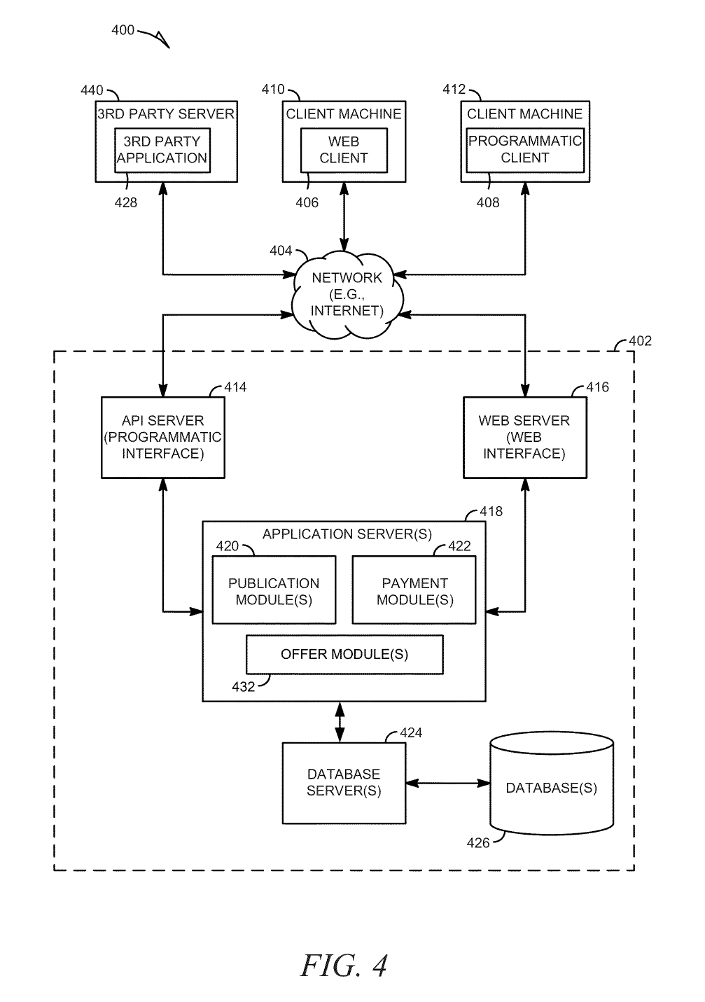

FIG. 4 is a block diagram illustrating a network-based system 400 for providing location-aware offers based on missed purchase opportunities, according to an example embodiment. The block diagram depicts a network-based system 400 (in the exemplary form of a client-server system), within which an example embodiment can be deployed is described. A networked system 402, in the example form of a network-based location-aware publication, advertisement, or marketplace system, that provides server-side functionality, via a network 404 (e.g., the Internet or WAN) to one or more client machines 410, 412. FIG. 4 illustrates, for example, a web client 406 (e.g., a browser, such as the Internet Explorer browser developed by Microsoft Corporation of Redmond, Wash.) and a programmatic client 408 (e.g., WHERE smartphone application from Where, Inc. of Boston, Mass.) executing on respective client machines 410 and 412. In an example, the client machines 410 and 412 can be in the form of a mobile device, such as mobile device 115.

An Application Programming Interface (API) server 414 and a web server 416 are coupled to, and provide programmatic and web interfaces respectively to, one or more application servers 418. The application servers 418 host one or more publication modules 420 (in certain examples, these can also include commerce modules, advertising modules, and marketplace modules, to name a few), payment modules 422, and location-aware offer modules 432. The application servers 418 are, in turn, shown to be coupled to one or more database servers 424 that facilitate access to one or more databases 426. In some examples, the application server 418 can access the databases 426 directly without the need for a database server 424.

The publication modules 420 may provide a number of publication functions and services to users that access the networked system 402. The payment modules 422 may likewise provide a number of payment services and functions to users. The payment modules 422 may allow users to accumulate value (e.g., in a commercial currency, such as the U.S. dollar, or a proprietary currency, such as “points”) in accounts, and then later to redeem the accumulated value for products (e.g., goods or services) that are advertised or made available via the various publication modules 420, within retail locations, or within external online retail venues. The payment modules 422 may also be configured to present or facilitate a redemption of offers, generated by the location-aware offer modules 432, to a user during checkout (or prior to checkout, while the user is still actively shopping). The location-aware offer modules 432 may provide real-time location-aware offers (e.g., coupons or immediate discount deals on targeted products or services) to users of the networked system 402. The location-aware offer modules 432 can be configured to use all of the various communication mechanisms provided by the networked system 402 to present offer options to users. The offer options can be personalized based on current location, time of day, user profile data, past purchase history, or recent physical or online behaviors recorded by the network-based system 400, among other things. While the publication modules 420, payment modules 422, and location-aware offer modules 432 are shown in FIG. 4 to all form part of the networked system 402, it will be appreciated that, in alternative embodiments, the payment modules 422 may form part of a payment service that is separate and distinct from the networked system 402. Additionally, in some examples, the location-aware offer modules 432 may be part of the payment service or may form an offer generation service separate and distinct from the networked system 402.

Further, while the system 400 shown in FIG. 4 employs a client-server architecture, the present invention is of course not limited to such an architecture, and could equally well find application in a distributed, or peer-to-peer, architecture system, for example. The various publication modules 420, payment modules 422, and location-aware offer modules 432 could also be implemented as standalone systems or software programs, which do not necessarily have networking capabilities.

The web client 406 accesses the various publication modules 420, payment modules 422, and location-aware offer modules 432 via the web interface supported by the web server 416. Similarly, the programmatic client 408 accesses the various services and functions provided by the publication modules 420, payment modules 422, and location-aware offer modules 432 via the programmatic interface provided by the API server 414. The programmatic client 408 may, for example, be a smartphone application (e.g., the WHERE application developed by Where, Inc.) to enable users to receive real-time location-aware personalized pricing options on their smartphones leveraging user profile data and current location information provided by the smartphone or accessed over the network 404.

FIG. 4 also illustrates a third party application 428, executing on a third party server machine 440, as having programmatic access to the networked system 402 via the programmatic interface provided by the API server 414. For example, the third party application 428 may, utilizing information retrieved from the networked system 402, support one or more features or functions on a website hosted by the third party. The third party website may, for example, provide one or more promotional, marketplace or payment functions that are supported by the relevant applications of the networked system 402. Additionally, the third party website may provide merchants with access to the local pricing modules 432 for configuration purposes. In certain examples, merchants can use programmatic interfaces provided by the API server 414 to develop and implement rules-based pricing schemes that can be implemented via the publication modules 420, payment modules 422, and location-aware offer modules 432.

### Example Offer Modules

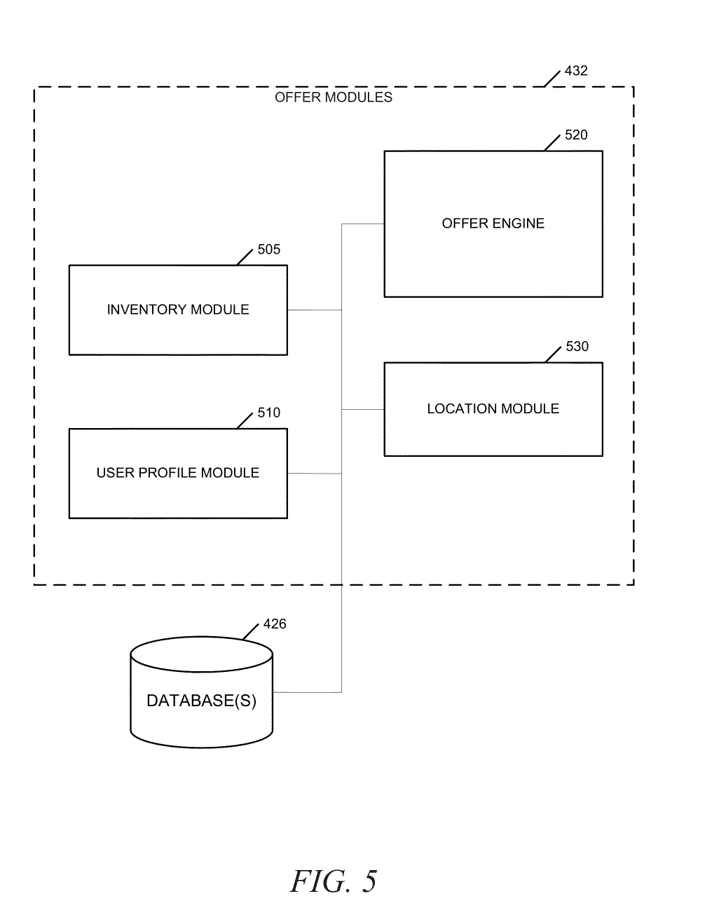

FIG. 5 is a block diagram illustrating location-aware offer modules 432, according to an example embodiment. In this example, the location-aware offer modules 432 can include an inventory module 505, a user profile module 510, an offer engine 520, and a location module 530. In an example, the location-aware offer modules 432 can access database 426 to store and/or retrieve offer rules, user profile date, and location data, as well as other information to enable location-aware offers to be generated and delivered.

In an example, the inventory module 505 can track inventory available at individual locations associated with a merchant using the networked system 402. The inventory module 505 can maintain inventory associated with products or services that a merchant has included within offer generation rules used by the offer engine 520 to generate location-aware offers. In certain examples, the inventory module 505 maintains inventory information within a local database, such as database 426. In another example, the inventory module 505 can be configured to access remote inventory information maintained by individual merchants. In additional examples, the inventory module 505 can be configured to interact with a third-party real-time inventory provider, such as MILO (from eBay, Inc. of San Jose, Calif.). The inventory module 505 can also be configured to deliver real-time (or near real-time) inventory information from multiple different sources. In some examples, each merchant may make inventory information available via different mechanism (e.g., API, XML feed, batch up loads, etc.). The inventory module 505 can convert from various incoming formats to a common format used by the offer engine 520 to generate location-aware offers based on current inventory available within individual local retail outlets.

In an example, the user profile module 510 is configured to obtain intended purchase information related to a specific user accessing the networked system 402. Intended purchase information can include a list of products or services that the user has demonstrated some interest in purchasing. In an example, the list of products or services that the user has demonstrated some interest in purchasing is called an intended purchase list. In certain examples, the intended purchase list can be created as soon as the user demonstrates interest in a single product or service (in other words, the list may, in certain situations, contain only one item). In an example, the user profile module 510 can access user profile data generated by a user on one or more network-based systems, such as networked system 402, to generate an intended purchase list. The intended purchase list can be generated based on accessing information such as Internet browsing history, wish lists, virtual shopping carts (or abandoned virtual shopping carts), auction bid history, auction watch lists, or virtual wallet activities (e.g., storing a coupon or purchasing an associated item). Any user related data that can be accessed over a network, such as the Internet, may be gathered and used by the user profile module 510 to maintain an intended purchase list. In some examples, an intended purchase list may be maintained within a third party system, such as third party server 440, and merely accessed by the user profile module 510 over the network 404. In other examples, the user profile module 510 can access an intended purchase list maintained by the user on a mobile device, such as mobile device 115.

In an example, the location module 530 is configured to receive location data from a mobile device, such as mobile device 115, and determine from the location data one or more participating merchant locations that are within a pre-defined proximity. In some examples, the location module 530 can receive GPS-type coordinates (e.g., longitude and latitude), which can be used to establish a current location associated with a mobile device (and, thus, a user of the mobile device). Using the longitude and latitude coordinates, the location module 530 can determine if any merchants with physical locations registered with the networked system 402 are in proximity to the current location associated with the user. In certain examples, the location module 530 can receive other location determining information from a mobile device. For example, some merchants may broadcast specific wireless network signals that can be received by a mobile device, such as mobile device 115. Once received, the mobile device 115 can include programming or circuitry to translate the signal into a specific location, or the mobile device 115 can simply retransmit the unique signal to the location module 530. In an example, a merchant location can transmit a unique SSID, which the location module can be programmed to interpret as identifying a specific merchant location. In another example, the merchant may broadcast a unique SSID within all of its locations and the location module 530 can be programmed to use a combination of the unique SSID and other location data (e.g., GPS coordinates or cell tower locations) to identify a specific location.

In an example, the offer engine 520 is configured to generate and deliver location-aware offers for available inventory based on missed purchase opportunities (e.g., for a product or service that a user has explicitly or implicitly indicated an interest in purchasing). In this example, the offer engine 520 can use input from the inventory module 505, the user profile module 510, and the location module 530 in conjunction with offer-rules defined by participating merchants to generate location-aware offers. In an example, the offer engine 520 can generate a location-aware offer for a particular user and transmit the offer over the network 404 to a client machine 412. In certain examples, the client machine 412 can be a mobile device, such as mobile device 115. In an example, the offer engine 520 can generate offers based on rules input by a merchant. For example, a merchant can enter a rule that instructs the offer engine 520 to offer a 20% discount to any user who has indicated an interest in purchasing an item within a certain category of inventory items maintained by the merchant. In another example, a merchant can enter a rule that instructs the offer engine 520 to discount items up to 25% in order to meet a specific price at which a user has indicated a willingness to purchase. For example, if a user enters a bid on an item up for auction, the offer engine 520 can generate an offer from a merchant selling the same item to meet the bid price (so long as it does not exceed a 25% discount).

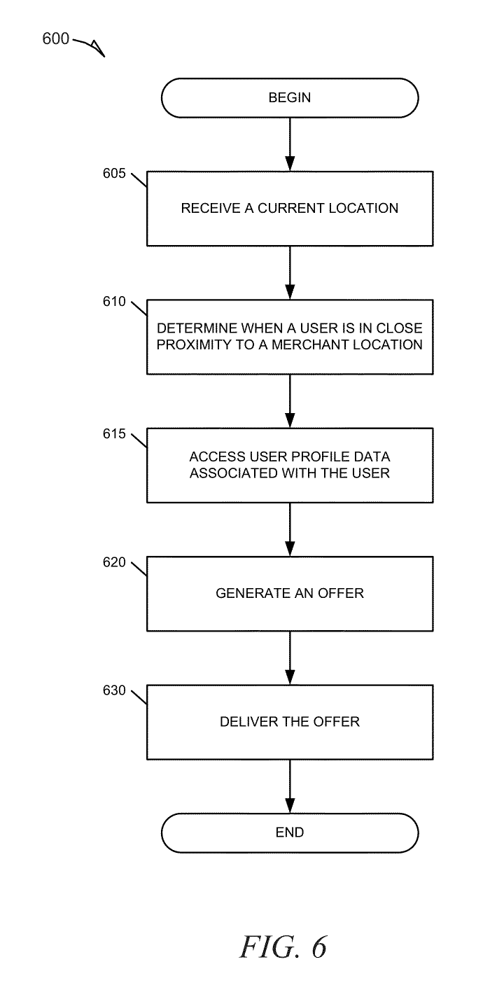

Additional details regarding the functionality provided by the location-aware offer modules 432 are detailed in reference to FIGS. 6-8.

### Example Methods

FIG. 6 is a flowchart illustrating a method 600 for delivering offers based on missed purchase opportunities, according to an example embodiment. In an example, the method 600 can include operations such as: receiving a current location 605, determining when a user is in close proximity to a merchant location 610, accessing user profile data associated with the user 615, generating an offer 620, and delivering the offer 630. In this example, the method 600 can begin at 605 with the location module 530 receiving information representing a current location from a mobile device 115. At 610, the method 600 can continue with the location module 530 determining, based on the information received from the mobile device 115, whether a user associated with the mobile device is in close proximity to a merchant location (e.g., a physical retail outlet). When the user is determined to be in close enough proximity, which can be defined by a merchant, the method 600 can continue at 615. At 615, the method 600 continues with the user profile module 510 accessing user profile data associated with the user of the mobile device 115. In certain examples, the user profile data can be stored on the mobile device 115. In other examples, the user profile data can be aggregated at the networked system 402. Aggregation of the user profile data can be performed based on registration information provided by the user to the networked system 402. For example, a user can register common online shopping or auction sites with the networked system 402. Subsequently, the networked system 402 can poll the sites provided by the user for information that can be analyzed to determine intended purchase targets.

At 620, the method 600 can continue with the offer engine 520 generating an offer based on information obtained or determined by the inventory module 505, the user profile module 510, and the location module 530. As discussed above, the offer engine 520 can generate offers based on rules developed by merchants to encourage purchases of certain inventory items. In an example, offers can be generated based on a current location associated with a user and some past purchase intent demonstrated by the user. At 630, the method 600 can conclude with the offer engine 520 delivering an offer over the network 404 to a user, such as client machine 412.

In an example, an offer generated by the offer engine 520 can be delivered to a mobile device, such as mobile device 115, via email, text message, multi-media message, or similar messaging mechanism. Once received, a user of the mobile device can display the offer at check-out (point of sale (POS) system) to receive the discount. In some examples, the offer can include a bar code, two-dimensional matrix code (such as a QR (quick response) code), or similar scan-enabled image that a merchant's POS system can recognize to provide the offered deal. In certain examples, the mobile device 115 can be running an application, such as programmatic client 408, that interacts with the networked system 402. In this example, the offer engine 520 can communicate via the application running on the mobile device 115. In certain examples, the application running on the mobile device 115 can exchange information with the offer engine 520 as well as a merchant system (e.g., a POS system) or more generally with the networked system 402.

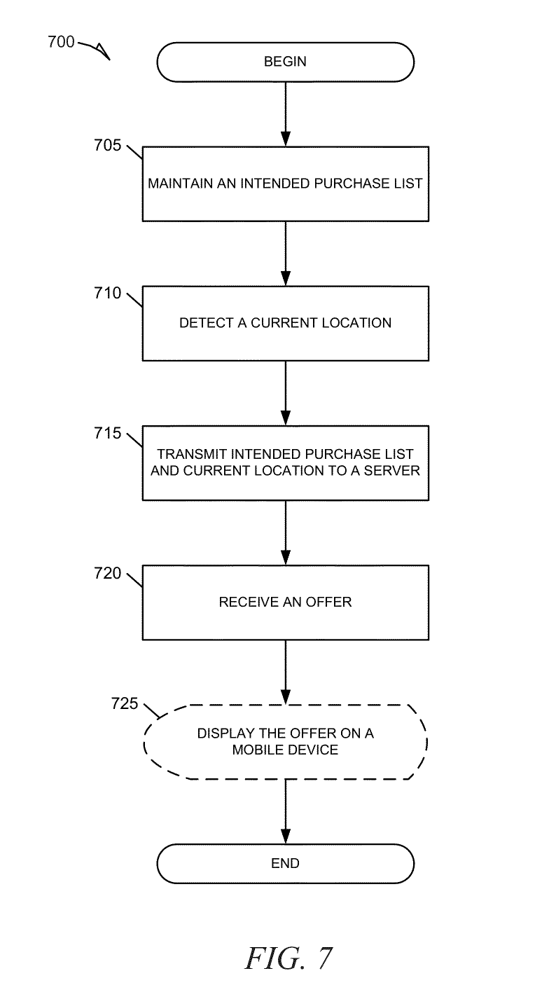

FIG. 7 is a flowchart illustrating a method 700 for receiving location-aware offers based on missed purchase opportunities, according to an example embodiment. In an example, the method 700 can include operations such as: maintaining an intended purchase list 705, detecting a current location 710, transmitting the intended purchase list and current location to a server 715, receiving an offer 720, and optionally displaying the received offer on a mobile device 725. In this example, the method 700 includes operations that cart be performed on a client device, such as client machine 412 or mobile device 115.

At 705, the method 700 can begin with a user maintaining an intended purchase list on a mobile device 115. In an example, the intended purchase list can be maintained automatically by the mobile device 115 after the user inputs information identifying network-based systems that may contain information indicating an interest by the user in making a particular purchase. In an example, the user can input account information for web sites, such as WWW.EBAY.COM or WWW.AMAZON.COM, which may collect information such as watch lists or wish lists accessible by the mobile device 115. In certain examples, the user can manually input items into an intended purchase list maintained on the mobile device 115.

At 710, the method 700 can continue with the mobile device 115 detecting a current location associated with the mobile device. As discussed above, the current location detection can involve GPS or similar location sensing as well as use of other location determining capabilities of the mobile device 115. In certain examples, the user can be prompted to enter information identifying a current location. Manual entry of a current location may be used in situations when other automatic mechanisms fail due to environmental conditions or technical failures. In some examples, the mobile device 115 cart prompt a user to verify a current location. In these examples, verifying the current location can include selecting from a list of near-by retail locations, such as when a user is within a retail mall with many retail locations in close proximity and potentially limited precision on location determination by a mobile device.

At 715, the method 700 can continue with the mobile device 115 transmitting the intended purchase list and the current location to an online service, such as a service operated within the networked system 402. In an example, the networked system 402 can use the intended purchase list and current location to generate one or more offers from participating merchants, refer back to the discussion of FIG. 5 and FIG. 6 for additional details related to operations that may be performed by the networked system 402 in generating an offer.

At 720, the method 700 can continue with the mobile device 115 receiving an offer from the networked system 402 (or a similar system hosting an online service capable of generating location-aware offers). Finally, at 725, the method 700 can conclude with the mobile device 115 displaying the offer. In certain examples, the mobile device 115 can notify a user with a sound, vibration, or indicator light when an offer is received.

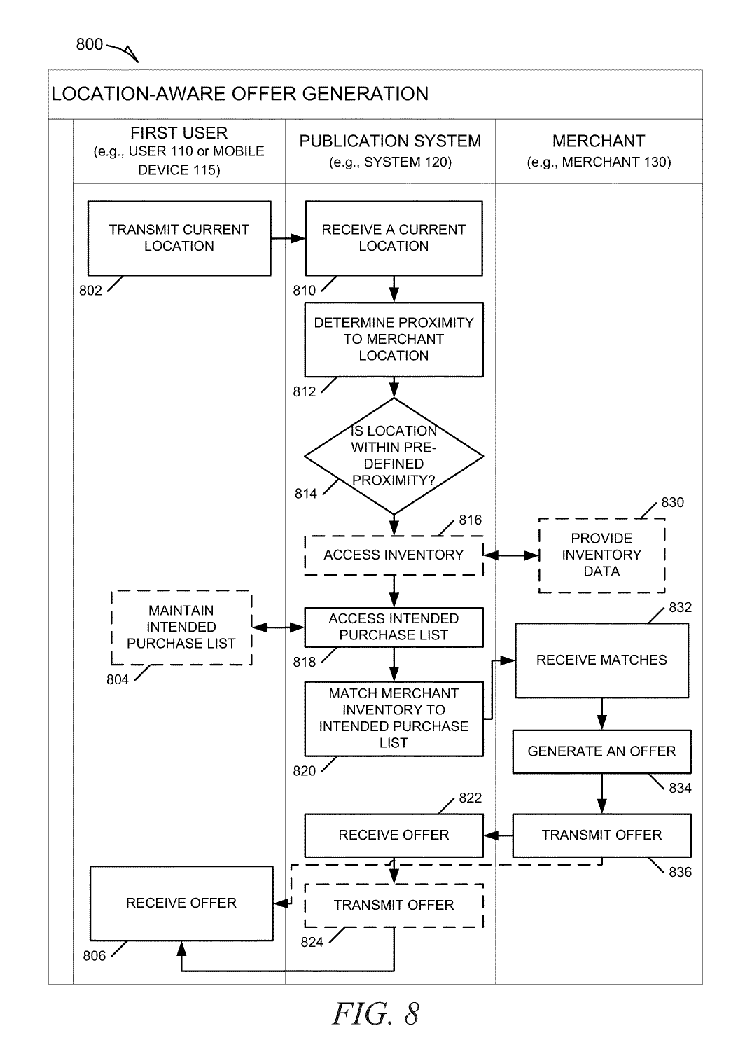

FIG. 8 is a swim-lane chart illustrating a method 800 for providing location-aware offers based on missed purchase opportunities, according to an example embodiment. In an example, the method 800 can include operations for transmitting a current location at 802, receiving a current location at 810, determining proximity to a merchant location at 812, determining whether the current location is within a pre-defined proximity to a merchant location at 814, accessing an intended purchase list at 818, matching merchant inventory to the intended purchase list at 820, receiving matches at 832, generating an offer at 834, transmitting an offer at 836, and receiving an offer at 822 or 806. Optionally, the method 800 can also include operations for maintaining an intended purchase list at 804, accessing inventory at 816, providing inventory data at 830, and transmitting (re-transmitting) the offer at 824. In general, the method 800 depicts a variation on the methods discussed above in reference to FIG. 6 and FIG. 7. The primary variation depicted within method 800 is the various operations performed by the merchant 130 on systems owned and/or operated by the merchant. All of the operations depicted within FIG. 8 occurring within merchant 130 operated systems can also be performed within a publication system, such as the network-based publication system 120.

At 802, the method 800 can begin within the mobile device 115 transmitting a current location to the network-based publication system 120. In certain examples, the network-based publication system 120 can periodically poll registered mobile devices, such as mobile device 115, for current location data. At 810, the method 800 continues with the network-based publication system 120 receiving data, from the mobile device 115 indicating the current location of the mobile device 115. At 812, the method 800 continues with the network-based publication system 120 using the current location data to determine a proximity to a merchant location associated with the mobile device 115. In an example, the network-based publication system 120 can determine proximity to all participating merchants at operation 812. At operation 814, the method 800 can continue with the network-based publication system 120 determining whether the current location associated with the mobile device 115 is within a pre-defined proximity of any retail locations associated with participating merchants, such as merchant 130. If the current location associated with the mobile device 115 is not within a pre-defined proximity, the method 800 concludes.

At 816, the method 800 can continue with the network-based publication system 120 optionally accessing inventory data from one or more of the participating merchants, such as merchant 130. At 830, the method 800 continues with the merchant 130 providing inventory data relevant to local?retail locations (e.g., retail locations within the pre-defined proximity of the current location). As discussed previously, merchant inventory data, can be maintained by a merchant, such as merchant 130, by a network-based system, such as the network-based publication system 120, or by a third party, such as the third party server 440 (e.g., a service such as that provided by MILO).

At 818, the method 800 can continue with the network-based publication system 120 accessing an intended purchase list. In an example, intended purchase lists can be maintained for registered users within the network-based publication system 120. In some examples, the network-based publication system 120 can build an intended purchase list for a particular user in real-time (or near real-time) by accessing user profile data stored within the network-based publication system 120 or on a third party system that the network-based publication system 120 can access. In this example, a user may provide the network-based publication system 120 with credentials to access third party systems that contain the user profile data, such as purchase histories, watch lists, wish lists, browsing history, and the like.

At 820, the method 800 can continue with the network-based publication system 120 matching merchant inventory (e.g., inventory available at a local retail outlet for the merchant 130) to items on the user's intended purchase list. The matching process can be implemented at a variety of levels of granularity. In an example, the matching can be done down to the specific product (e.g., model number). In other examples, the matching can be implemented using some form of fuzzy logic to match product or service types (e.g., cordless drills or house cleaning services). In still other examples, the matching can include a hierarchical matching method moving from specific to general. For example, if the merchant has inventory of the exact model of cordless drill on the user's intended purchase list, then this item will be returned as a match. However, if the merchant sells a different cordless drill with similar features, then the matching algorithm can return that item as a match. In certain examples, the matching algorithm can include a scoring function that scores the quality of the match. In these examples, the match score can be used within merchant offer generation rules to determine whether to generate a given offer. For example, if the match score is below a certain threshold, the offer engine 520 may not generate a related offer.

At 832, the method 800 can continue with the merchant 130 receiving any relevant matches between available inventory and a user's intended purchase list. In this example, the method 800 can continue at 834 with the merchant 130 generating an offer based on the received match or matches. At 836, the method 800 can continue with the merchant 130 transmitting the offer over a network, such as network 105, to the network-based publication system 120 and/or optionally directly to the mobile device 115. In an example, the merchant 130 will only communicate directly with the network-based publication system 120, so the offer will be relayed by the network-based publication system 120 to the mobile device 115 (operation 824 transmitting the offer from the network-based publication system 120 to the mobile device 115). However, in certain examples, the merchant 130 may be provided with sufficient information to transmit the offer directly to the mobile device 115. In either example, the method 800 can conclude at 806 with the mobile device receiving a location-aware offer based on entries in an intended purchase list.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

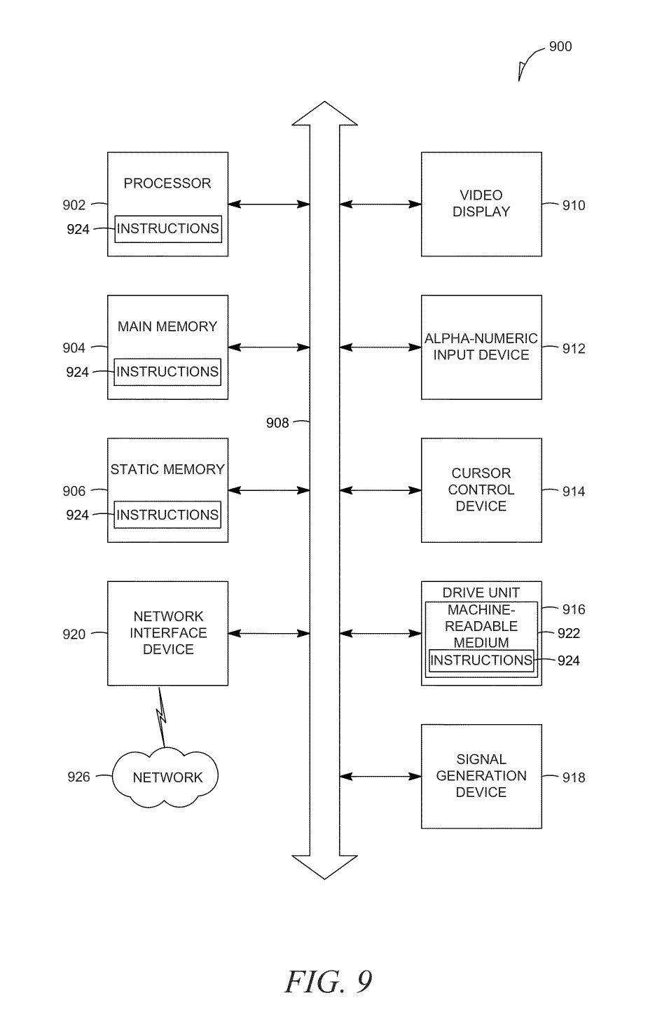

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software) 924 embodying or used by any one or more of the methodologies or functions described herein. The instructions 924 may also reside, completely or at least partially, within the main memory 904, static memory 906, and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., Erasable Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks,

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a LAN, a WAN, the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for making contextual recommendations to users on a network-based marketplace have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. (Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the fill range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method to deliver a location-aware offer based on past intent to purchase, the method comprising:
receiving, at a network-based system, current location data specifying a current location of a client device associated with a user;
determining, using one or more processors within the network-based system, when the user is within a pre-defined proximity to a merchant location based on the current location data;
when the user is determined to be within the pre-defined proximity to the merchant location, accessing, from the network-based system, user profile data associated with the user, the user profile data including an intended purchase list including at least one product or service that the user has demonstrated an interest in purchasing;
generating, using the one or more processors within the network-based system, an offer based on matching inventory available at the merchant location to one or more items on the intended purchase list associated with the user; and
delivering, over a network connection between the network-based system and a client device associated with the user, the offer to the client device?.

2. The method of claim 1, wherein the determining when the user is within the pre-defined proximity to the merchant location includes detecting when the client device enters the merchant location.

3. The method of claim 1, wherein the determining when the user is within the pre-defined proximity to the merchant location includes detecting when the client device enters a geofence surrounding the merchant location.

4. The method of claim 1, wherein the determining when the user is within the pre-defined proximity to the merchant location includes detecting when the current location of the client device is within a pre-defined radius around the merchant location.

5. The method of claim 1, wherein the determining when the user is within the pre-defined proximity to the merchant location includes detecting a check-in associated with the merchant location on the client device.

6. The method of claim 1, further comprising:
receiving, at the network-based system, an intended purchase indicator associated with the user; and
storing, using the one or more processors within the network-based system, the intended purchase indicator within the intended purchase list for the user.

7. The method of claim 6, wherein receiving the intended purchase indicator includes receiving information representative of an explicit or implicit action by the user representative of an interest in purchasing a particular product or service.

8. The method of claim 7, wherein receiving information representative of an explicit or implicit action by the user representative of an interest in purchasing a particular product or service includes receiving information representative of the user performing one of the following operations:
abandoning an item in a virtual shopping cart;
losing art auction after placing a bid within the auction;
losing a watched auction;
failing to bid on a watched auction;
placing an item on a wish list;
viewing a coupon associated with a particular product or service;
researching a particular product or service online; and
storing a coupon or offer associated with a particular product or service within a virtual wallet.

9. A method of receiving a location-aware offer on a mobile device, the method comprising:
maintaining, on the client device, an intended purchase list;
detecting, on the client device, a current location;
transmitting, to a network-based system, the intended purchase list and the current location detected by the client device; and
receiving, on the mobile device, an offer from a merchant associated with the current location, the offer generated by the network-based system based on matching inventory available from the merchant in proximity to the current location with one or more items on the intended purchase list.

10. The method of claim 9, wherein maintaining the intended purchase list includes storing input representative of a particular product or service received on the client device.

11. The method claim 9, wherein maintaining the intended purchase list includes polling one or more network-based merchant systems for user profile data associated with the user of the client device, the user profile data including information representative of an explicit or implicit action by the user representative of an interest in purchasing a particular product or service.

12. A system comprising:
a location module configured to:
receive a current location associated with a user from a mobile device; and
determine, based on the current location, when the user is within a pre-defined proximity to a merchant location;
a user profile module configured to access user profile data associated with the user, the user profile data including an intended purchase list including a plurality of products or services that the user has demonstrated an interest in purchasing;
an inventory module configured to maintain a current inventory of the merchant location; and
an offer engine configured to:
generate an offer based on matching one or more items within the current inventory to one or more items on the intended purchase list associated with the user; and
deliver the offer over a network connection between the system and the mobile device.

13. The system of claim 12, wherein the location module is further configured to determine when the user is within the pre-defined proximity to the merchant location by detecting when the client device enters the merchant location.

14. The system of claim 12, wherein the location module is further configured to determine when the user is within the pre-defined proximity to the merchant location by detecting when the client device enters a geofence surrounding the merchant location, the geofence defined by a merchant associated with the merchant location.

15. The system of claim 12, wherein the location module is further configured to determine when the user is within the pre-defined proximity to the merchant location by detecting when the current location of the client device is within a pre-defined radius around the merchant location.

16. The system of claim 12, wherein the location module is further configured to determine when the user is within the pre-defined proximity to the merchant location by detecting a check-in associated with the merchant location on the client device.

17. The system of claim 12, wherein the user profile module is further configured to:
receive an intended purchase indicator associated with the user; and
store the intended purchase indicator within the intended purchase list for the user.

18. The system of claim 17, wherein the user profile module is further configured to receive the intended purchase indicator by receiving information representative of an explicit or implicit action by the user representative of an interest in purchasing a particular product or service.

19. The system of claim 18, wherein the user profile module receives information representative of the explicit or implicit action by the user representative of an interest in purchasing a particular product or service including receiving information representative of the user performing one of the following operations:
abandoning an item in a virtual shopping cart;
losing an auction after placing a bid within the auction;
losing a watched auction;
failing to bid on a watched auction;
placing an item on a wish list;
viewing a coupon associated with a particular product or service;
researching a particular product or service online; and
storing a coupon or offer associated with a particular product or service within a virtual wallet.

20. A system comprising:
a network adaptor configured to send and receive data packets over a network;
a processor communicatively coupled to the network adaptor; and
a memory device, the memory device communicatively coupled to the processor and including instructions which, when performed on the processor, cause the processor to:
receive a current location from a client device via the network adaptor, the current location associated with a user;
determine when the user is within a pre-defined proximity to a merchant location;
when the user is determined to be within the pre-defined proximity to the merchant location, access user profile data associated with the user, the user profile data including an intended purchase list including a plurality of products or services that the user has demonstrated an interest in purchasing;
generate an offer based on matching inventory available at the merchant location to one or more items on the intended purchase list associated with the user; and
deliver, via the network adaptor, the offer to the client device.
